(19) United States
(12) Patent Application Publication
(10) Pub. No.: US 2026/0087878 A1
(43) Pub. Date: Mar. 26, 2026

(54) AN ARRANGEMENT AND A METHOD FOR RECOMMENDING GAMBLING GAMES IN A GAMBLING GAME SESSION FOR A USER OF A USER DEVICE

(71) Applicant: Fennica Gaming Oy, Helsinki (FI)

(72) Inventors: Luai MAHJNEH, Helsinki (FI); Timo KIISKINEN, Kerava (FI)

(21) Appl. No.: 18/898,573

(22) Filed: Sep. 26, 2024

(51) Int. Cl. G07F 17/32

(52) U.S. Cl. CPC G07F 17/323; G07F 17/3237; G07F 17/329

(57) ABSTRACT

An arrangement and a method, e.g. a computer-implemented method, for recommending gambling games in a gambling game session for a user of a user device, the game session comprising consecutive rounds of different gambling games. The method comprises collecting data during gameplay of a game relating to the user playing the game, and after the game has ended, presenting a proposed selection of games from a list of available games, wherein the proposed selection of games is prepared at least in part based on collected data relating to the user. The method further comprises receiving user selection of the next game from a list of proposed selection of games, starting the selected next game based on the received user selection, and repeating the steps of collecting data during gameplay of the selected game relating to the user playing the game, preparing proposed selection of games after the selected game has ended and receiving user selection for the next selected game and starting the next selected game based on the user selection until the game session is ended.

### TECHNICAL FIELD

The invention concerns in general the technical field of gaming solutions. More particularly, the invention concerns an arrangement and a method for managing an electronic lottery game for a user of a user device and/or an arrangement and a method for recommending gambling games in a gambling game session for a user of a user device.

### BACKGROUND

The development of communication technologies has enabled people to participate in online games with their devices, e.g. computers or mobile devices, over a communication network, such as Internet. A player accessing a gaming session connects to a gaming server with her/his device and the gaming session management and game itself can be least in part implemented or executed in the gaming server.

Also gambling games and lotteries can nowadays be implemented as online gambling and lottery games e.g. in online casinos and gambling sites. For example, document EP 1133338 discloses an online lottery solution in which a lottery agent determines a size of a set of electronic lottery tickets, and distribution of prizes, and request a lottery press to generate the set of electronic lottery tickets.

Another prior art solution is described in EP3893210A1 which relates to an electronic depleting pool lottery. In this publication there is, for a set of lottery tickets, at least a record that comprises at least an identifier of the set, prize distribution information and permutation information. When a lottery ticket is bought, an initial index value is assigned, and one or more permutations are performed to the initial index value, the result being a final index value. The prize of the lottery ticket is determined using the final index value and the prize distribution information.

The online lottery and/or gambling experience can be implemented for the user with a gaming solution in which the player plays a game with his or her device and the player is able to get the prize of the lottery he or she has earned from the game environment.

Different online gambling and lottery game environments can comprise a large number of games which the players can play. However, it is difficult to for the users or players to find games that they enjoy and as the game selection is difficult, the players can be playing only same games over and over again. Therefore, there is a need for a system which is able to assist the players and improve their gaming experience in an efficient and reliable manner.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a computer-implemented method, an arrangement and a computer program and a game system for assisting the players and improving their gaming experience in an efficient and reliable manner and e.g. to present a solution for managing an electronic lottery game for a user of a user device and/or for recommending gambling games in a gambling game session for a user of a user device.

The objects of the invention are reached by a computer-implemented method, an arrangement and a computer program according to a solution of the invention.

According to a first aspect the invention relates to a method, e.g. a computer-implemented method, for recommending gambling games in a gambling game session for a user of a user device, the game session comprising consecutive rounds of different gambling games. The method comprises collecting data during gameplay of a game relating to the user playing the game, after the game has ended, presenting a proposed selection of games from a list of available games, wherein the proposed selection of games is prepared at least in part based on collected data relating to the user, receiving user selection of the next game from a list of proposed selection of games, starting the selected next game based on the received user selection, and repeating the steps of collecting data during gameplay of the selected game relating to the user playing the game, preparing proposed selection of games after the selected game has ended and receiving user selection for the next selected game and starting the next selected game based on the user selection until the game session is ended.

In one embodiment of the invention the proposed selection of the games is a subset of all available games and/or does or does not comprise the previously played games of the game session.

In one embodiment of the invention determining list of recommended games is at least in part carried out by utilizing machine learning techniques.

In one embodiment of the invention the game session is carried out in a single game interface essentially throughout the game session.

In one embodiment of the invention the collected data relates at least to user interactions, feedback, preference of the user, gaming history of the user and/or commitment of the user for a certain game and/or a certain game type, and/or the data collected during gameplay of the game comprises at least one of the following: win/loss outcomes, game thematic, game universe, pace of the game, session duration, win frequency, game developer credentials.

In one embodiment of the invention the collected data is analyzed, and the analyzed data is used to determine proposed selection of games for a user, e.g. for a specific user, the games included in the list of proposed games for example based on demonstrated preferences and gameplay patterns of the user.

In one embodiment of the invention at least some of the data collected during the gameplay is stored as a floating-point number.

In one embodiment of the invention the user has a profile and at least part of the collected information or part of the information relating to the collected information is stored to the user profile and/or used in a subsequent game session for determining a list of recommended games in the subsequent game session.

In one embodiment of the invention the game session is started with a first selected game from a list of proposed games which list of proposed games are based on at least in part on collected data of at least one user's previous game sessions, e.g. stored in the user profile.

In one embodiment of the invention the game session is ended when a predefined criteria for ending the game session is fulfilled, the criteria for ending the game session comprising at least one of the following: the player has collected the drawn prize amount for the whole game session from the completed and/or played games of the game session, and/or the player has used all tokens available for playing.

In one embodiment of the invention the player is awarded a prize for the game session and wherein prize of a game of the game session is adjusted based on the user's achievement in the game of the game session, and/or the prize for the whole game session is drawn before the player starts to play the first game of the game session, and/or user achievements during the games of the game session do not have effect on the prize amount of the game session.

According to a second aspect, the invention relates to an arrangement, such as a computer and/or a server, for recommending gambling games for a user of device in a gambling game session, wherein the game session comprises consecutive rounds of different games. The arrangement is configured to collect data during gameplay of a game relating to the user playing the game, after the game has ended, to present a proposed selection of games from a list of available games, wherein the proposed selection of games is prepared at least in part based on collected data relating to the user, to receive user selection of the next game from a list of proposed selection of games, to start the selected next game based on the received user selection, and to repeat the steps of collecting data during gameplay of the selected game relating to the user playing the game, preparing proposed selection of games after the selected game has ended and receiving user selection for the next selected game and starting the next selected game based on the user selection until the game session is ended.

In one embodiment of the invention the arrangement is configured to carry out a method according to any embodiment of the invention.

According to another aspect, the invention may relate to a method, e.g. a computer-implemented method, for managing an electronic lottery game for a user of a user device, the game comprising consecutive rounds of different minigames. The method comprises starting the game with a first minigame, collecting data during the gameplay of the first minigame relating to achievement of the user, storing the collected achievement data of the user, and when the first minigame ends, determining prize of the first minigame based at least in part on the achievement data of the user. The method further comprises repeating starting a next minigame, collecting achievement data during the gameplay of the played minigame relating to achievement of the user, storing the collected achievement data of the user, and determining prize of the played minigame based at least in part on the achievement data of the user until a predefined criteria for ending the game is fulfilled. The method further comprises sending information relating to the prize of the game to the user device based at least in part on the prizes of the minigames of the game after the predefined criteria for ending the game is fulfilled.

In one embodiment of the invention the prize for the game is drawn before the player starts to play the first minigame of the game.

In one embodiment of the invention the criteria for ending the game comprises at least one of the following: the player has collected the drawn and/or full prize amount for the game from the completed and/or played minigames of the game, and/or all the selected minigames are played and/or completed by the user.

In one embodiment of the invention the next minigame of the game is selected based at least in part on the user's achievement performance and/or the remaining prize amount for the whole game.

In one embodiment of the invention the minigames played in the game are different minigames from each other, and/or selected from a list of available minigames.

In one embodiment of the invention a prize is available for each minigame of the game, the prize being zero or more, and the prize of the whole game is a combination of the prizes of the minigames of the game.

In one embodiment of the invention the prize for a minigame is adjusted based on the user's achievement in the minigame of the game, and/or wherein user achievements during the minigames of the game do not have effect on the prize amount of the game.

In one embodiment of the invention the maximum prize for a minigame is less than the prize for the game, wherein the maximum prize amount is divided between the minigames of the game, which maximum prize of each minigame is awarded for the user if the user successfully executes the required task(s) of the minigame.

In one embodiment of the invention the prize win amount per minigame is speeded up if the user's performance is below a threshold level, e.g. the user is performing poorly, in multiple minigames of the game.

In one embodiment of the invention the minigames are selected from a list of available minigames by the user and/or by the system, and the next minigame is selected when a previous minigame ends, or the list of selected minigames is prepared before the user starts to play minigames of the game.

In one embodiment of the invention further data is collected from the user and/or minigames played by the user during the gameplay of the mini games in the game and/or after a minigame of the game has ended, and/or the method comprises preparing a proposed selection of minigames from a list of available minigames for the user, wherein the proposed selection of minigames is prepared at least in part based on the collected data, wherein the collected data relates to at least one of the following: user interactions, feedback, preference of the user, gaming history of the user and/or commitment of the user for a certain minigame and/or game type, win/loss outcomes, game thematic, game universe, pace of the minigame, game duration, win frequency, game developer credentials.

According to another aspect, the invention may relate to an arrangement, such as a computer and/or a server, for managing an electronic lottery game for a user of a user device, the game comprising consecutive rounds of different minigames. The arrangement is configured to start the game with a first minigame, to collect data during the gameplay of the first minigame relating to achievement of the user, to store the collected achievement data of the user, and when the first minigame ends, to determine prize of the first minigame based at least in part on the achievement data of the user. The arrangement is configured to repeat starting a next minigame, collecting achievement data during the gameplay of the played minigame relating to achievement of the user, storing the collected achievement data of the user, and determining prize of the played minigame based at least in part on the achievement data of the user until a predefined criteria for ending the game is fulfilled. The arrangement is further configured to send information relating to the prize of the game to the user device based on the prize of the minigames of the game after the predefined criteria for ending the game is fulfilled.

In one embodiment of the invention the arrangement is configured to carry out a method according to any embodiment of the invention.

According to one aspect, the invention relates to a computer program, the computer program comprising instructions which, when the program is executed by a computing apparatus, e.g. the arrangement, cause the computing apparatus to carry out the method according to any embodiment of the invention, e.g. any method as defined above.

According to one aspect, the invention relates to a computer-readable medium comprising the computer program according to an embodiment of the invention.

The present invention is able to provide a solution which is able to assist the players and improve their gaming experience in an efficient and reliable manner. In one embodiment of the invention the solution assists the users or players finding games that they enjoy. The game experience can also be kept in single game session or single game so that the different games of the game session or different minigames of the game can be played seamlessly one after another and can be selected automatically and/or based on information relating to the user, which information is collected e.g. during the game or game session.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a game system according to an example embodiment of the invention.

FIG. 2 illustrates schematically an arrangement according to an example embodiment of the invention.

FIG. 3 illustrates schematically aspects relating to managing an electronic lottery game for a user of a user device according to an example embodiment of the invention.

FIG. 4 illustrates schematically an example embodiment which can be used between different minigames.

FIG. 5 illustrates schematically aspects relating to recommending gambling games for a user of a user device according to an example embodiment of the invention.

FIG. 6 illustrates schematically an example method according to one embodiment of the invention.

FIG. 7 illustrates schematically an example method according to one embodiment of the invention.

### Description of the Exemplifying Embodiments

The specific examples provided in the description given below should not be construed as limiting the scope and/or the applicability of the appended claims. Lists and groups of examples provided in the description given below are not exhaustive unless otherwise explicitly stated.

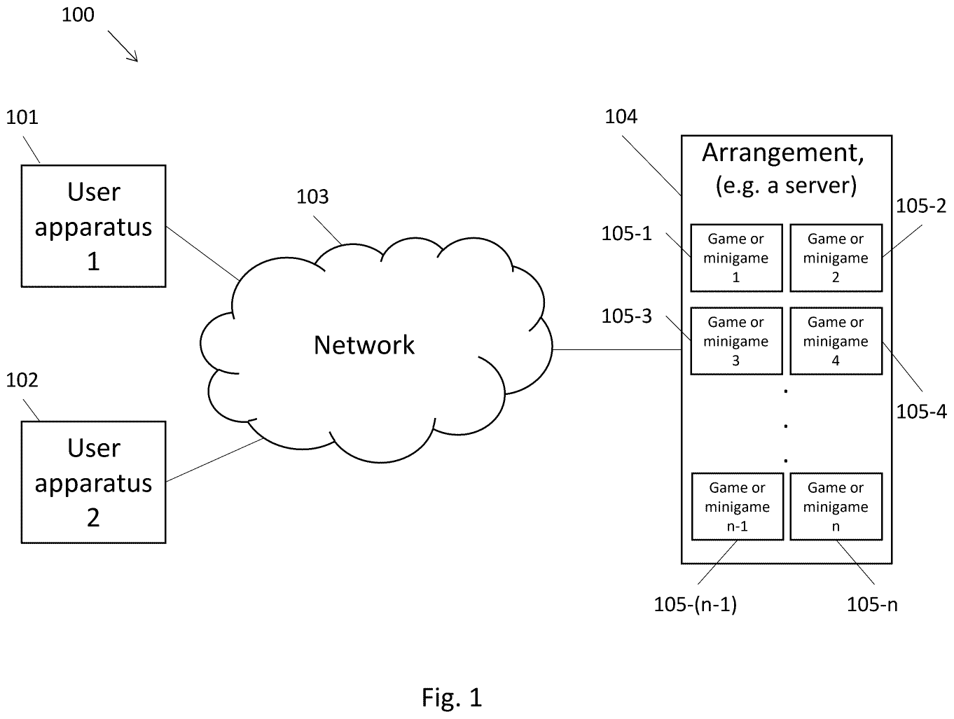

FIG. 1 illustrates schematically an example embodiment of a game system 100. In accordance with the example embodiment the system 100 comprises an arrangement 104, such as a computer or a server, configured to execute operations enabling execution of electronic games (for example games or minigames 105-1 . . . 105-n), such as an electronic lottery and/or an electronic gambling game, in the arrangement 104. The execution of the electronic game in the arrangement 104 at least refers to a hosting of at least one user apparatus 101, 102 to access to the electronic game so that the users, e.g. players, of the user apparatuses 101, 102 may participate to the electronic game. An access to participate to the electronic game hosted by the arrangement 104 may be established to user apparatuses 101, 102 over a communication network 103, such as Internet, intranet, virtual private network, or any other suitable network. The communication connections between communicating entities may be established by applying wireless or wired communication technologies, or any combination of these. The communication connections between communicating entities can be protected by using methods known for transmitting confidential data over a data network.

In addition to the above-described operations the arrangement 104 may be configured to perform further operations with respect to the execution of the electronic game in the arrangement 104, such as managing the participation of the user(s) in the electronic game in accordance with one or more predefined rules. This may include, but is not limited to, a utilization of user data stored e.g. in a data storage e.g. implemented as a database. The data storage may store user data including, but not limited to, achievement data for a user, date collected during gameplay relating to a user, user profile data comprising e.g. personal data (for example name, address, phone number, email address), credit data relating to the electronic game in question wherein the credit data may be defined as a value of money or tokens or any similar which are at least in part required to access to the electronic game and/or to buy the electronic tickets to the game, such as an electronic lottery and/or an electronic gambling game.

The user apparatuses 101, 102 may include any suitable computing device for accessing the electronic game and for executing the electronic game e.g. as an online based electronic game, such as lottery or gambling game, through the communication connection to the arrangement 104. For example, the user apparatus 101, 102 may comprise a display device configured to display information in relation to the electronic lottery and I/O device(s), such as one or more keys or buttons, a keyboard, a touchscreen, a touchpad and/or a mouse, that enables a user to interact during the electronic game or game session and to send and/or receive information from the arrangement 104. The user apparatus(es) 101, 102 may include a processing unit that includes a number of processors that is coupled to a memory unit. The processing unit can be configured to execute a number of computer programs enabling a control of user apparatus 101, 102 according to user instructions received via I/O device(s) and/or from the arrangement 104. The user apparatus 101, 102 may be, but is not limited to, a desktop computer, a laptop or a tablet computer, a smartphone, a handheld mobile device including a cellular telephone, a game console, an electronic gaming machine (EGM) and the like.

The arrangement 104, such as a server or a computer, can comprise a database in which information for electronic tickets, such as lottery tickets, is stored. In one embodiment of the invention, the arrangement can comprise an external database or can be connected to at least one external database in which electronic tickets are stored which can be utilized in an electronic game provided by the arrangement. The arrangement can also comprise information relating to different games or minigames 105-1 . . . 105-n, e.g. stored in a memory, storage means and/or database.

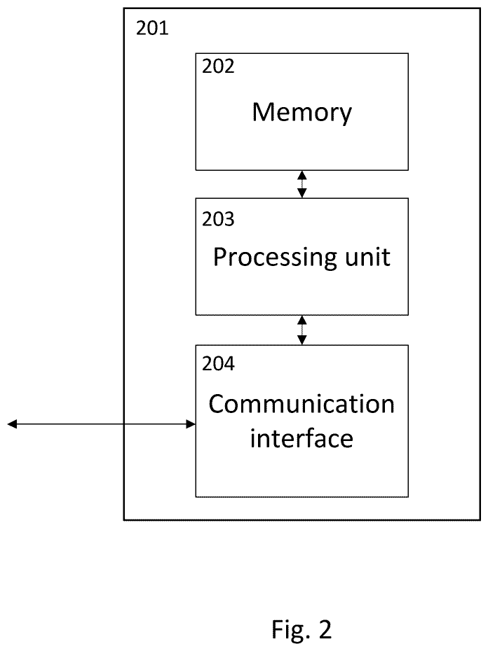

An example of the arrangement 104, such as a computer or a server, is schematically illustrated in FIG. 2. The arrangement 104, e.g. implanting functionalities of the server, may be for example a computer device. In other words, the arrangement of FIG. 2 may be configured to perform operations as is described in the description. For sake of clarity, it is worthwhile to mention that the block diagram of FIG. 2 depicts some components of an entity that may be employed to implement a functionality of the arrangement.

The arrangement 201 of FIG. 2 comprises at least a memory 202 and a processing unit 203 which comprises at least one processor. The memory 202 may store data, but also computer program code, causing an operation in a manner as is described e.g. in the forthcoming description. The arrangement may further comprise a communication interface 204, such as a wireless communication interface or a communication interface for wired communication, or both to communicate with other entities. The communication interface 204 may thus comprise one or more modems, antennas, and any other hardware and software for enabling an execution of the communication e.g. under control of the processing unit 203. Furthermore, I/O (input/output) components may be arranged, together with the processing unit 203 and a portion of the computer program code, to provide a user interface for receiving input from an operator and/or providing output to the operator of the arrangement when necessary. In particular, the I/O components may include user input means, such as one or more keys or buttons, a keyboard, a touchscreen, or a touchpad, etc. The I/O components may also include output means, such as a loudspeaker, a display, or a touchscreen. The components of the arrangement may be communicatively connected to each other via data bus that enables transfer of data and control information between the components.

The memory 202 and at least a portion of the computer program code stored therein may further be arranged, with the processing unit 203, to cause the arrangement to perform at least a portion of a method e.g. as is described in the forthcoming description. The processing unit 203 may be configured to read from and write to the memory 202. Although the processing unit 203 is depicted as a respective single component, it may be implemented as respective one or more separate processing components. Similarly, although the memory 202 is depicted as a respective single component, it may be implemented as respective one or more separate components, some, or all of which may be integrated and/or removable, and/or may provide permanent, semi-permanent, dynamic and/or cached storage.

The computer program code may comprise computer-executable instructions that implement functions that correspond to steps implemented in a method according to an embodiment of the invention when loaded into the processing unit 203 of the respective arrangement 104. As an example, the computer program code may include a computer program consisting of one or more sequences of one or more instructions which may relate to an execution of the electronic game, such as lottery and/or a gambling game, but also other operations, such as to a management of users in the electronic game in a manner as is described in the description. The processing unit 203 is able to load and execute the computer program by reading the one or more sequences of one or more instructions included therein from the memory 202. The one or more sequences of one or more instructions may be configured to, when executed by the processing unit 203, cause the arrangement to perform a method according to any embodiment of the invention. Hence, the arrangement may comprise at least one processing unit 203 and at least one memory 202 including the computer program code for one or more programs, the at least one memory 202 and the computer program code configured to, with the at least one processor 203, cause the arrangement, e.g. implementing a server, to perform at least a method according to any embodiment of the invention.

The computer program code may be provided e.g. a computer program product comprising at least one computer-readable non-transitory medium having the computer program code stored thereon, which computer program code, when executed by the processor, causes the arrangement to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code may comprise a proprietary application, such as computer program code for causing an execution of the method in the manner as described in the description herein.

Any of the programmed functions mentioned may also be performed in firmware or hardware adapted to or programmed to perform the necessary tasks.

The operation of the arrangement, e.g. server, 104 may be implemented with a plurality of arrangement, e.g. as a distributed computing environment. The distributed computing environment may be implemented as a cloud computing system wherein a number of arrangements are harnessed to execute operations to generate an implementation of a method as is described herein. In the distributed computing environment, the plurality of arrangements are each configured to perform a dedicated task or dedicated tasks and the cooperation of the arrangements cause the operation of the server to occur in the manner as is described herein.

In one embodiment of the invention users can purchase electronic tickets, e.g. electronic lottery tickets, with which they are able to win prizes, and/or gambling game tickets with which they can participate to a gambling game. Purchasing can be carried out for example with the user apparatus. In one embodiment of the invention the lottery can be an electronic instant lottery and/or the tickets can be electronic lottery tickets.

When a user wishes to buy an electronic ticket, such as an electronic lottery ticket, the user can contact e.g. a lottery agency and pay the lottery ticket, e.g. by paying a given fee, for example with a user device. Having paid the fee, the user can get an access to an electronic ticket for example in an electronic ticket database and e.g. a receipt of the legally made payment can be provided to the user.

In one embodiment of the invention the electronic ticket, e.g. an electronic lottery ticket, can give the user a right to play one game session and/or one game, comprising e.g. minigames. The game can be a lottery-based game and/or gambling game, and the game session can be a lottery game session and/or a gambling game session.

The user can take necessary measures to access the gaming session of the computer game (e.g. a gambling game or a lottery game) with a user apparatus, e.g. a terminal device. The accessing may occur over a web browser or a dedicated application. The request of accessing to the gaming session may initiate an interaction between the arrangement, e.g. a gaming server, and the user apparatus so that the player indicates over the communication channel that she/he is willing to play the computer game in question (e.g. a gambling game or a lottery game) and is willing to acquire a number of tickets. In response to a completion of the preparations to access the gaming session a player management portion may indicate to a gaming engine portion that the player is allowed to play the computer game in question (e.g. a gambling game or a lottery game), i.e. allowed to access the gaming session. The player management portion may also indicate a number of tokens allocatable to the player.

In one embodiment of the invention, in response to entering to a game or gaming session, the player may be requested to select the number of tickets for the gaming session. The selection may comprise the selection of values for the number of tickets. The selection procedure may comprise that the arrangement, such as a gaming server, outputs a menu for selection so that the player receives the menu with her/his user apparatus, e.g. over a display of the user apparatus, and interacts with the user apparatus, e.g. with the I/O devices so that the selection may be communicated back to the arrangement.

In one embodiment of the invention when the ticket allows to user to purchase a lottery ticket, the choice of the lottery ticket can be given to the user, or the arrangement, e.g. a server or a lottery agency's computer, can make the choice on behalf of the user. In one embodiment of the invention the arrangement can make a random choice of the lottery ticket. In one embodiment of the invention the selected lottery ticket is/are removed from the lottery ticket database or is marked as sold, to avoid that the same lottery ticket is sold twice.

In one embodiment of the invention, in response to receiving information, e.g. from a user apparatus, that an electronic ticket is bought, a prize of the ticket can be determined. Based on determined prizes of each lottery ticket, the determined prize information can be sent to the user apparatus. The prize information can be presented to the user via the user apparatus, e.g. in a user interface of the user apparatus.

The prize of the lottery ticket and/or a prize from a gambling game can be provided to the user e.g. by a lottery agency. In one embodiment of the invention the user apparatus can contact the prize payment service and present the required information, e.g. the ticket, lottery ticket and/or a proof that the user he has received for the ticket. The prize payment service can e.g. check that this particular ticket has been sold in its sold ticket database. In one embodiment of the invention, the prize payment service can verify the proofs to confirm that the user has purchased the ticket, such as lottery ticket. The prize payment service can further check that the ticket really is a winning ticket and that the corresponding prize has not been previously collected. If all the required verifications are successfully accomplished and no errors are observed, the prize can be paid to the user.

In one embodiment of the invention, after successfully buying a lottery ticket, the user contacts the key holder and presents the proof of his legal purchase of a given lottery ticket he has been given by the lottery agency. In one embodiment of the invention the proof can include an unambiguous lottery ticket and/or lottery ticket identifier, by means of which the key holder can search, in the key database, the key which decrypts the encryption of this particular lottery ticket. The key holder can deliver the key and the proof of its reception to the user, who now has access both to the lottery ticket and to the key with which he can decrypt the lottery ticket in order to find out whether it is a winning lottery ticket or not. The user also has proofs of having received access to the lottery ticket and the key according to the rules. This is only one example method and also other alternative methods can be used in the solution of the invention.

Based on the purchased ticket(s) the user can be allowed to play games in a game session and/or play minigames in a game.

In one embodiment of the invention one game or game experience is created for the user to play, which game can comprise at least one or multiple minigames. The minigames, e.g. lottery minigames, can be organized into cohesive sets to enable a seamless and fast paced gameplay experience. An adaptive algorithm can be incorporated for adjusting the type of minigames and/or bonuses based on user performance during the play session. In one embodiment of the invention the minigame(s) of the game can selected for example based on the ticket's win amount. After the user has ended one minigame, another minigame can be selected and started, e.g. for so long that the user has collected the full win amount of the ticket from the minigames, for example by successfully executing them. After the game, the user can be shown the amount they won as well as the score from the minigames.

The minigames can be for example short and simple challenges that last only a few seconds each. During a minigame, and/or each time a minigame starts, the user can be shown a hint of what is their task to succeed. A minigame can have a running timer (for example 3 - 5 seconds) for the user to succeed in the task. By successfully executing the task, the user can be rewarded with part of the ticket winning amount, leading to the whole win amount by the end of the short game comprising multiple minigames. In one embodiment, if the user fails the task, no money is awarded to them.

In one embodiment of the invention the user's input doesn't influence the amount of money they can win but the user's input only affects their playing experience. In one embodiment some of the minigames in the game can be impossible to execute successfully, to cover the case of non-winning/empty ticket. In case the user has a ticket with no win, even successfully executing the task can lead to a failure.

In one example embodiment one ticket and/or a game (for which one ticket can be required) can contain for example 1-5 or 3-5 minigames, lasting for example 10-50 seconds in total. Each ticket can have a predetermined win amount, e.g. 10 euros. The ticket win amount can be divided between multiple minigames, e.g. to 1-5 or 3-5 minigames, and the player is rewarded in the case of successful execution of each minigame which results in the complete win amount of the ticket.

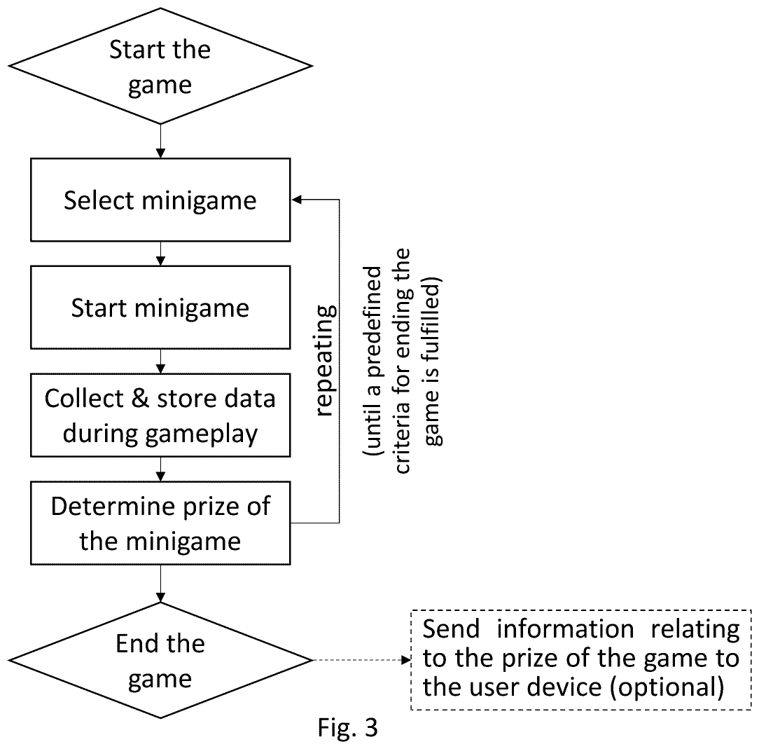

FIG. 3 shows an example of how the game can be carried out in one embodiment of the invention. When the game is started, a minigame is selected and started. The minigame can be selected by the system or the user. During the gameplay of the minigame data is collected and stored relating to the user's performance in the minigame. During and/or after the gameplay of the minigame a prize for the minigame is determined for the user. The game is continued by selecting and starting a new minigame and collecting information during gameplay and determining prize of the minigame as long as the predefined criterion for ending the game is fulfilled. The system can use for example 0-1 floating-point numbers for storing the data collected during gameplay that reflect analyzed features relating to the player.

The solution of FIG. 3 can be implemented at least in part for example in the arrangement 104 of FIG. 1 or arrangement 201 of FIG. 2, e.g. with a hardware and software. More specifically, the arrangement may execute computer programs stored in memory 202 and executed by the processing unit 203 of the arrangement, e.g. a gaming server, wherein the computer program may cause an execution of a gaming engine portion and/or a player management portion. In accordance with the example embodiment the gaming engine portion may be configured to execute the computer game in question and related operations therein for the players and/or the player management portion may be configured to perform player related management operations, such as evaluating a right to access to the gaming session executed by the gaming engine portion as well as monitoring the users performance or actions in a game, a minigame and/or a game session. In accordance with an example embodiment of the invention the computer game executed by the gaming engine portion of the gaming server may be a gambling game or a lottery game into which players may access at any time.

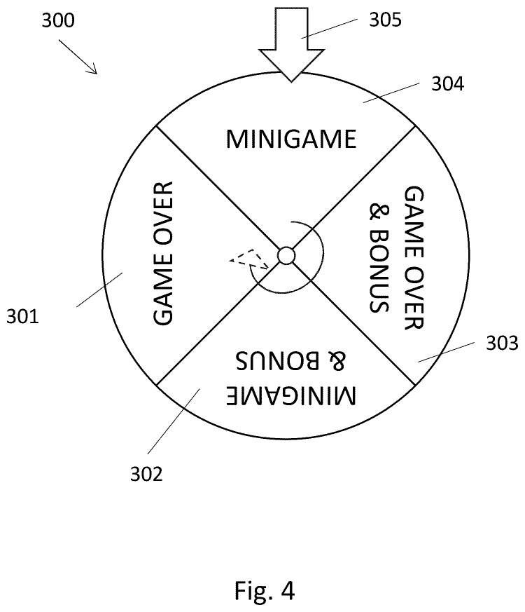

In one embodiment of the invention a spinning wheel can be used in the game. FIG. 4 presents an example of a spinning wheel 300 which can be used in the solution of the invention. The spinning wheel 300 can have different options or areas, such as starting a new minigame 304, starting a new minigame and receiving an extra bonus 302, ending the game and receiving an extra bonus 303 and/or ending the game without a bonus 301. When the spinning wheel is used, the wheel is spinning and slowing down to a stop in which case the selection arrow 305 shows which option the user is awarded. In one embodiment of the invention the game can start (optionally) with a spin of the wheel. In one embodiment of the invention the first spin always lands either on “Minigame” or “Minigame & bonus”. Spinning the wheel can in one example embodiment be carried out between minigames, and/or before starting a first minigame of the game, and/or after ending the last minigame of the game. If for example wheel is used between minigames, after the minigame, the user is returned to the wheel for another spin.

In one embodiment of the invention a bonus win can be rewarded to speed up the ticket win amount accumulation. This bonus can be used for example in certain cases, e.g. when the user with a winning ticket is performing poorly and/or below a certain threshold level in the minigames.

In one embodiment of the invention one game session or game session experience is created for the user to play, which game session can comprise at least one or multiple games. In one embodiment of the invention a recommendation method is provided which is integrated within a game environment, such as a gambling game environment. This embodiment is able to operate seamlessly during an active game session and e.g. offer personalized game suggestions without the need for restarting or exiting the current game interface.

The recommendation algorithm can prove intelligent recommendations e.g. for the next game to be played outside of the previous game played. The algorithm can analyze the player's past gaming for example player's preferences, spending and/or engagement. This makes it possible to provide personalized recommendations as the player moves from one game to another. The system can use for example 0-1 floating-point numbers that reflect these analyzed features relating to the player. For example, if a player has enjoyed certain types of games or achieved a high level of engagement in a certain game, the algorithm can recommend the next game to play that matches those preferences. This personalized approach can enhance the players'experience and help them discover new, interesting games outside of their game portfolio. It is possible to utilize machine learning based solutions or models when preparing recommendations for a user.

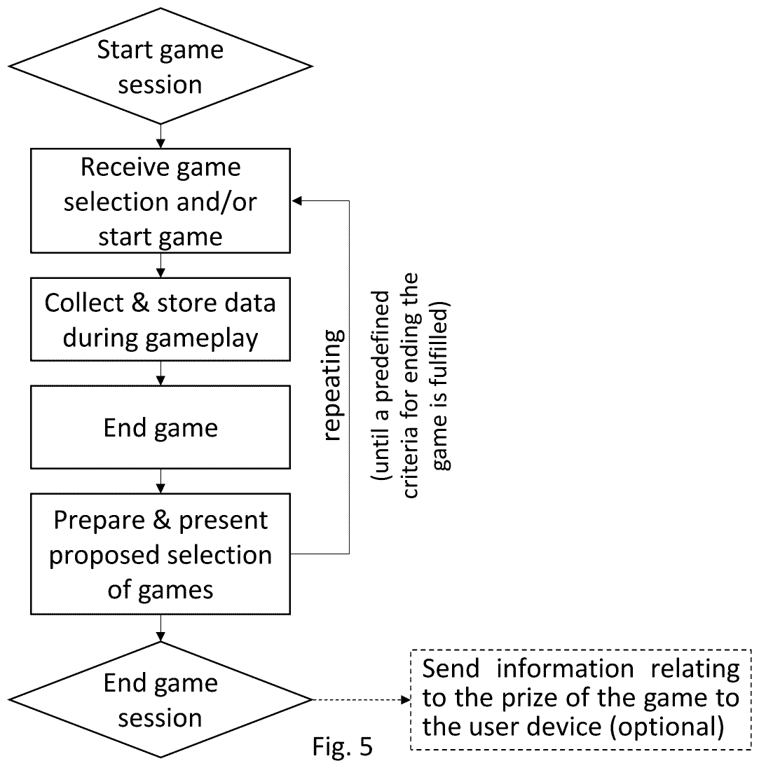

FIG. 5 presents one example embodiment of the invention. In the solution of this embodiment the player starts the game session, and a first game of the game session is selected for the user. The game can be a gambling game and/or the game session can be a gambling game session. The game can be selected by the user or by the system. After receiving the selection of the game, the game is started, and data is collected and stored during gameplay of the game. During the game session, user interactions and feedback are analyzed to understand preferences. During the same game session, the player profiles can be refined and/or any game(s) based on similar preferences can be recommended. When the game is ended the system prepares and presents proposed selection of games prepared for the user based at least in part on the collected data. The player chooses the next game from the proposed games and their selections and gaming history are analysed to understand preferences. Then the selected new game of the game session can be started. These above-mentioned steps are continued as long as the game session is ended (e.g. based on a predefined criteria) in order to collect and assess the user's game session and gaming activity and preferences of the user.

The solution of FIG. 5 can be implemented at least in part for example in the arrangement 104 of FIG. 1 or arrangement 201 of FIG. 2, e.g. with a hardware and software. More specifically, the arrangement may execute computer programs stored in memory 202 and executed by the processing unit 203 of the arrangement, e.g. a gaming server, wherein the computer program may cause an execution of a gaming engine portion and/or a player management portion. In accordance with the example embodiment the gaming engine portion may be configured to execute the computer game in question (e.g. a gambling game or a lottery game) and related operations therein for the players and/or the player management portion may be configured to perform player related management operations, such as evaluating a right to access to the gaming session executed by the gaming engine portion as well as monitoring the users performance or actions in a game, a minigame and/or a game session. In accordance with an example embodiment of the invention the computer game executed by the gaming engine portion of the gaming server may be a gambling game or a lottery game into which players may access at any time.

In one embodiment of the invention game and/or minigame suggestions or proposals can be provided in an ongoing game session or game for example in real time. This allows players to transition smoothly to new gaming experiences within the same game session or game, thereby maintaining engagement and interest.

At least one of the following information can be collected and analyzed for preparing game recommendations: win/loss outcomes, game thematic, game universe, pace of the game, session duration, win frequency and/or game developer credentials. Recommendations, for example recommendations for games, can be generated based on data and/or information collected from within the current gaming environment. This ensures for example high relevance and contextual accuracy.

In one embodiment of the invention machine learning techniques can be used and the system can e.g. continuously adapt to individual player profiles, offering increasingly personalized game recommendations that align with the player's preferences and playstyle. Also games across different categories can be suggested and/or proposed for the player. For example, a player engaged in a slow-paced slot game could be recommended a fast-paced game diversifying their gaming experience within the game session.

In one embodiment of the invention the examples and/or embodiments used for a game session, e.g. a gambling game session, can also be used for a game comprising minigames, in which case the selection of minigames can be carried out as the selection of games of a game session presented in different examples and/or embodiment relating to games and/or game sessions. In one embodiment of the invention achievement performance of the user can be taken into account when providing and/or selecting a minigame, e.g. next minigame, for the user for example as discussed with the embodiment of a game selection in a game session.

Different mechanics for playing a game and/or a minigame in the solution of the invention can be used. These can comprise at least one of the following: clicking, swiping, finger gesture, guessing.

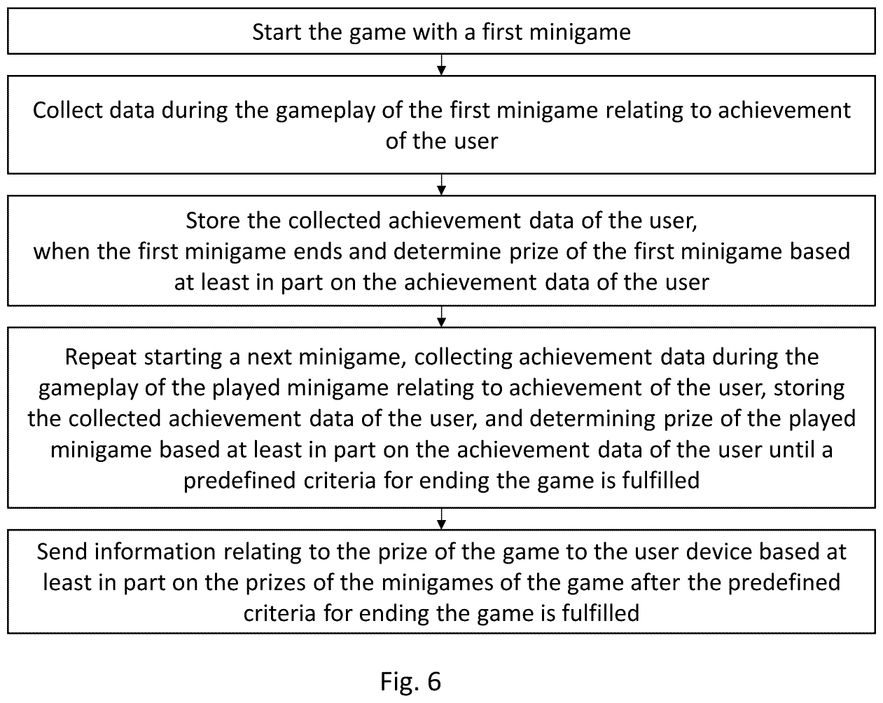

FIG. 6 describes one embodiment of the method according to the invention. The example method, e.g. a computer implemented method, of FIG. 6 comprises starting the game with a first minigame, collecting data during the gameplay of the first minigame relating to achievement of the user, and storing the collected achievement data of the user. When the first minigame ends, the method further comprises determining prize of the first minigame based at least in part on the achievement data of the user. The method further comprises repeating starting a next minigame, collecting achievement data during the gameplay of the played minigame relating to achievement of the user, storing the collected achievement data of the user, and determining prize of the played minigame based at least in part on the achievement data of the user until a predefined criteria for ending the game is fulfilled. The method further comprises sending information relating to the prize of the game to the user device based at least in part on the prizes of the minigames of the game after the predefined criteria for ending the game is fulfilled.

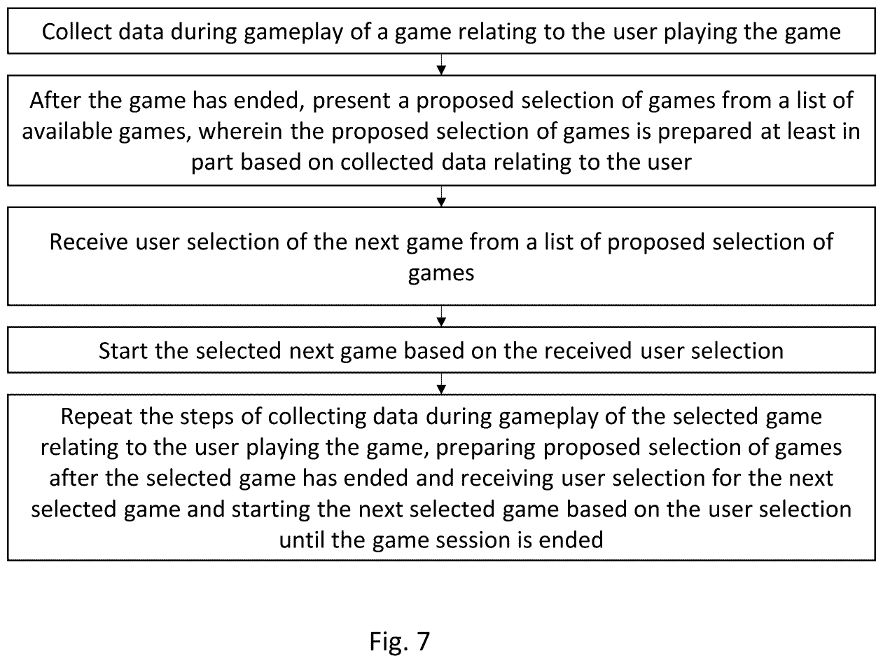

FIG. 7 describes one embodiment of the method according to the invention. The example method, e.g. a computer implemented method, of FIG. 7 comprises collecting data during gameplay of a game relating to the user playing the game, after the game has ended, presenting a proposed selection of games from a list of available games, wherein the proposed selection of games is prepared at least in part based on collected data relating to the user. The method further comprises receiving user selection of the next game from a list of proposed selection of games, starting the selected next game based on the received user selection, and repeating the steps of collecting data during gameplay of the selected game relating to the user playing the game, preparing proposed selection of games after the selected game has ended and receiving user selection for the next selected game and starting the next selected game based on the user selection until the game session is ended.

In one embodiment of the invention achievement data and/or data collected from the user during a game and/or game session, e.g. for generating recommendation or proposals, comprises at least one of the following:
Information related to user behavior attributes, e.g. one of the following:
How much money is spent on a certain game in a certain time period, e.g. per day/week/month (e.g. EUR)
   How often a certain game is played
   How much time has passed since the last session of playing a certain game
   What is the ratio of playing electronic games versus games on physical channels
   Whether a bet has already been placed on an upcoming event (e.g. lottery, betting event)
   Whether a certain game has already been played earlier this week
   Whether a certain game has already been played in this session and/or during same day (e.g. using real-time data streams)
   Social interactions of the user, such as friends lists, guild memberships, and/or interaction types.
Information related to performance metrics, e.g. one of the following:
   Skill and/or volatility level of a user, for example measured through rankings, win/loss ratios, and/or in-game statistics.
   Learning curve of a user, for example speed at which a player improves or adapts to new games.
   Engagement metrics, such as game session lengths, frequency of play, and number of active days when playing.
Information related to personalization data, e.g. one of the following:
   Preferred genres of a user, for example based on historical data and/or explicit preferences.
   Visual and audio preferences, e.g. preferred art styles, graphics fidelity, and/or sound design.
   Control schemes, for example preferred input devices and/or control configurations.
   Platform preferences, favored gaming platforms, such as PC, consoles and/or mobile.
Information related to contextual information, e.g. one of the following:
   Time of day, e.g. gaming habits related to specific times.
   Location data, such as geographic location affecting game recommendations, e.g., cultural relevance.
   Device usage patterns, which devices are used at different times or locations by a user.
Information related to psychometric attributes, e.g. one of the following:
   Personality traits, for example based on psychological models, e.g. Big Five personality traits.
   Mood detection, for example by using device sensors and/or self-reported mood data to influence game recommendations.
   Cognitive styles, for example preferred types of problem-solving, thinking patterns, and learning preferences of a user.
Information related to other attributes, e.g. one of the following:
   Biometric feedback, e.g. heart rate, eye tracking, and/or facial expressions to gauge engagement and emotional responses.
   Voice analysis, e.g. tone and/or pitch analysis during voice chats for example to assess emotional state or fatigue.
   Face recognition, e.g. for identifying player emotions or engagement levels.
   Augmented Reality (AR) interactions, e.g. preferences in AR settings, interactions, and/or immersion levels.
   Virtual Reality (VR) immersion preferences, e.g. comfort levels with various VR intensities and/or interaction types.
   Genetic markers, such as hypothetical future attribute where certain genetic predispositions might influence game preference.
   Environmental sensors, e.g. room temperature, lighting, and noise levels to adapt game recommendations based on physical environment comfort.
   Wearable technology data, by e.g. using data from smartwatches and/or fitness trackers to assess physical activity levels and potentially recommend games that match user energy levels.
Information related to social and cultural attributes, e.g. one of the following:
   Language preferences, e.g. preferred languages for games and/or their content.
   Cultural interests, for example games that align with user's cultural background or interests.
   Influencer and community preferences, e.g. influence of gaming communities and/or personalities on user preferences.
Information related to demographics, e.g. one of the following:
   Age, e.g. providing insight into generational preferences and/or trends.
   Gender, e.g. for understanding gender-based preferences for more tailored recommendations or content.
   Postal code, e.g. for offering geographical segmentation for localized services and/or content.
Information related to location, e.g. one of the following:
   Device, such as mobile phone and/or computer, location data, e.g. real-time geographical positioning for immediate contextual relevance.
   Distance to certain locations, such as sports stadiums, e.g. specific interest inference, for example for sports-related content, events and/or promotions.
Information related to time, e.g. one of the following:
   Day of the week, for example for differentiating weekdays from weekends for timing promotions or content.
   Day of the month, for example for identifying paydays and/or month-end trends for targeted offers.
   Hour: Time-of-day, for example for targeting for content delivery when users are most likely to engage.
Information related to sustainability, e.g. one of the following:
   Sustainability grouping for classifying users or content based on environmental or social responsibility criteria, targeting those who prefer sustainable options.
Information related to front-end features, e.g. one of the following:
   Device type, e.g. mobile device type, such as iOS and/or Android, for example for tailoring app experiences or content based on operating system-specific features or limitations.
   Browser type and/or version, e.g. for optimizing web content based on compatibility and performance across different browsers and versions.
   Additional front-end characteristics, e.g. leveraging other device or software specifics, such as screen resolution, language settings, or accessibility preferences.
Information related to possible gaming context and solutions, e.g. one of the following:
   eInstant
   eCasino
   Multiplayer
   EGM/VLT
   eDraw
   Sports Betting
   Social Gaming
   Skill-Based Gaming
   eBingo
   eKeno

In one embodiment of the invention the solution is able to enable responsible gambling. The solution can incorporate real-time monitoring and analysis of gambling behavior, allowing for the identification of patterns that may indicate risky or harmful gambling habits. By recognizing these patterns early, the solution can guide users towards more responsible gambling choices, potentially offering recommendations for games with lower risk profiles or suggesting breaks based on their activity. This proactive approach can support a safer gambling environment, where players remain within their comfort zones and limits. The solutions personalization ensures that gambling experiences are tailored to individual user preferences. By analyzing various attributes, including gameplay behavior, financial commitment, and engagement frequency, the system can intelligently recommend games that e.g. not only align with users'interests but also with their gambling behavior. This customization enhances enjoyment and satisfaction, making gambling or lottery games a more positive and engaging experience for every user. With real-time data streams and analytics, the solution can e.g. provide users with insights into their gambling habits, offering a clear overview of their spending, frequency, and preferences. This transparency can empower users, enabling them to make more informed decisions about their gambling activities. By being aware of their behavior, users can adjust their habits, opting for games that match their risk tolerance and personal goals. The solution's ability to recommend a diverse range of games and activities can help e.g. to. prevent users from overspending or overindulging in a single type of gambling activity. By introducing users to new games and betting options, the solution can encourage exploration within a controlled and moderated environment. This variety not only keeps the gambling experience fresh and exciting but also aids in preventing the development of compulsive gambling behaviors.

The specific examples provided in the description given above should not be construed as limiting the applicability and/or the interpretation of the appended claims. Lists and groups of examples provided in the description given above are not exhaustive unless otherwise explicitly stated.

1. A method, e.g. a computer-implemented method, for recommending gambling games in a gambling game session for a user of a user device, the game session comprising consecutive rounds of different gambling games, wherein the method comprises:
collecting data during gameplay of a game relating to the user playing the game,
after the game has ended, presenting a proposed selection of games from a list of available games, wherein the proposed selection of games is prepared at least in part based on collected data relating to the user,
receiving user selection of the next game from a list of proposed selection of games,
starting the selected next game based on the received user selection, and
repeating the steps of collecting data during gameplay of the selected game relating to the user playing the game, preparing proposed selection of games after the selected game has ended and receiving user selection for the next selected game and starting the next selected game based on the user selection until the game session is ended.

2. A method according to claim 1, wherein the proposed selection of the games is a subset of all available games and/or does or does not comprise the previously played games of the game session.

3. A method according to claim 1, wherein determining list of recommended games is at least in part carried out by utilizing machine learning techniques.

4. A method according to claim 1, wherein the game session is carried out in a single game interface essentially throughout the game session.

5. A method according to claim 1, wherein the collected data relates at least to user interactions, feedback, preference of the user, gaming history of the user and/or commitment of the user for a certain game and/or a certain game type, and/or
wherein the data collected during gameplay of the game comprises at least one of the following: win/loss outcomes, game thematic, game universe, pace of the game, session duration, win frequency, game developer credentials.

6. A method according to claim 1, wherein the collected data is analyzed and the analyzed data is used to determine proposed selection of games for a user, e.g. for a specific user, the games included in the list of proposed games for example based on demonstrated preferences and gameplay patterns of the user.

7. A method according to claim 1, wherein at least some of the data collected during the gameplay is stored as a floating-point number.

8. A method according to claim 1, wherein the user has a profile and at least part of the collected information or part of the information relating to the collected information is stored to the user profile and/or used in a subsequent game session for determining a list of recommended games in the subsequent game session.

9. A method according to claim 1, wherein the game session is started with a first selected game from a list of proposed games which list of proposed games are based on at least in part on collected data of at least one user's previous game sessions, e.g. stored in the user profile.

10. A method according to claim 1, wherein the game session is ended when a predefined criteria for ending the game session is fulfilled, the criteria for ending the game session comprising at least one of the following:
the player has collected the drawn prize amount for the whole game session from the completed and/or played games of the game session, and/or the player has used all tokens available for playing.

11. A method according to claim 1, wherein the player is awarded a prize for the game session and wherein prize of a game of the game session is adjusted based on the user's achievement in the game of the game session, and/or
wherein the prize for the whole game session is drawn before the player starts to play the first game of the game session, and/or
wherein user achievements during the games of the game session do not have effect on the prize amount of the game session.

12. An arrangement, such as a computer and/or a server, for recommending gambling games for a user of device in a gambling game session, wherein the game session comprises consecutive rounds of different games, wherein the arrangement is configured:
to collect data during gameplay of a game relating to the user playing the game,
after the game has ended, to present a proposed selection of games from a list of available games, wherein the proposed selection of games is prepared at least in part based on collected data relating to the user,
to receive user selection of the next game from a list of proposed selection of games,
to start the selected next game based on the received user selection, and
to repeat the steps of collecting data during gameplay of the selected game relating to the user playing the game, preparing proposed selection of games after the selected game has ended and receiving user selection for the next selected game and starting the next selected game based on the user selection until the game session is ended.

13. An arrangement according to claim 12, wherein the arrangement is configured to carry out a method.

14. A computer program comprising instructions which, when executed by a computer, such as a server, cause the computer to carry out the method according to claim 1.

15. A computer-readable medium comprising the computer program according to claim 14.
